(19) United States
(12) Patent Application Publication
(10) Pub. No.: US 2021/0326665 A1
(43) Pub. Date: Oct. 21, 2021

(54) TWO-DIMENSIONAL BARCODE ENCRYPTION METHOD, TWO-DIMENSIONAL BARCODE TRANSMISSION SYSTEM AND STORAGE MEDIUM

(71) Applicant: SHANGHAI DOBE INNOVATION TECHNOLOGY DEVELOPMENT CO., LTD., Shanghai (CN)

(72) Inventor: Jiajia Dong, Shanghai (CN)

(73) Assignee: SHANGHAI DOBE INNOVATION TECHNOLOGY DEVELOPMENT CO., LTD., Shanghai (CN)

(21) Appl. No.: 16/489,014

(22) PCT Filed: Aug. 17, 2018
(86) PCT No.: PCT/CN2018/100983

§ 371 Date: Aug. 27, 2019

(30) Foreign Application Priority Data
Apr. 26, 2018 (CN) 201810387448.1
Jun. 4, 2018 (CN) 201810562967.7

(51) Int. Cl. G06K 19/06

(52) U.S. Cl. CPC G06K 19/06037

(57) ABSTRACT

A 2D barcode encryption method, a 2D barcode transmission system and a storage medium are provided. The method includes: generating a first character string of a first numeral system based on information of a user; converting the first character string into a second character string of a second numeral system using a preset codebook, wherein the preset codebook is updated according to a first preset period, and a base number of the second numeral system is greater than that of the first numeral system; and generating a 2D barcode using the second character string. Security of access control for a shared space may be improved.

### CROSS-REFERENCE TO RELATED APPLICATIONS

This application is the national phase of International Application No. PCT/CN2018/100983, filed on Aug. 17, 2018, which claims the benefit of priority to Chinese Patent Application No. 201810562967.7, filed on Jun. 4, 2018, and entitled “TWO-DIMENSIONAL BARCODE ENCRYPTION METHOD, TWO-DIMENSIONAL BARCODE TRANSMISSION SYSTEM AND STORAGE MEDIUM”, and Chinese Patent Application No. 201810387448.1, filed on Apr. 26, 2018, and entitled “SHARED SPACE MANAGEMENT SYSTEM”, the entire disclosure of which are incorporated herein by reference.

### TECHNICAL FIELD

The present disclosure generally relates to security and protection field, and more particularly, to a two-dimensional (2D) barcode encryption method, a 2D barcode transmission system and a storage medium.

### BACKGROUND

Existing access control devices generally identify users through Identification (ID) cards, Integrated Circuit (IC) cards, passwords, fingerprints and so on. The access control devices compare acquired user information with pre-stored user information to determine whether to open a door.

However, 2D barcodes used in the existing access control devices are too long, and thus it takes a relatively long time to recognize the 2D barcodes. In the case of a large number of users, the users need to queue up for scanning the 2D barcodes. Some users use a text string to form content of a 2D barcode and further generate the 2D barcode. The content of the 2D barcode presented in a clear text can be identified directly, and thus the meaning of the 2D barcode can be guessed easily to perform camouflage, which causes low security. For access control devices in different sites, such as a gym, a conference room or an elevator, a user needs to display different 2D barcodes, which bring the user great inconvenience. Some users may copy available 2D barcodes of other users to use repeatedly. If the 2D barcodes are divulged, the security of the access control device will be seriously affected.

A shared space is a space shared by multiple users. For example, a single office can be shared with people throughout the building or even in the whole society. Because of the large number of users involved in the shared space, existing 2D barcode encryption methods cannot meet security requirements of the shared space for access control.

### SUMMARY

Embodiments of the present disclosure may improve security of access control for a shared space.

In an embodiment of the present disclosure, a 2D barcode encryption method is provided, including: generating a first character string of a first numeral system based on information of a user; converting the first character string into a second character string of a second numeral system using a preset codebook, wherein the preset codebook is updated according to a first preset period, and a base number of the second numeral system is greater than that of the first numeral system; and generating a 2D barcode using the second character string.

Optionally, the base number of the first numeral system is 10, and the base number of the second numeral system is 64.

Optionally, the preset codebook includes a plurality of characters arranged in order, wherein the order is updated according to a second preset period.

Optionally, the plurality of characters are selected from a group consisting of numbers from 0 to 9, capital letters from A to Z, lowercase letters from a to z, and punctuation.

Optionally, the information of the user includes ID of the user, and the first character string includes a character corresponding to the ID of the user.

Optionally, the character corresponding to the ID of the user is disposed in a preset position of the first character string.

In an embodiment of the present disclosure, a 2D barcode transmission system is provided, including: a server; a plurality of sub control devices disposed in a plurality of shared spaces, wherein each of the plurality of sub control devices includes: a sub station; a 2D barcode scanning device, configured to scan a 2D barcode on a User Equipment (UE) to acquire information carried by the 2D barcode, wherein the information carried by the 2D barcode is transmitted by the sub station, the 2D barcode is generated by the UE or a server according to the above 2D barcode encryption method, and the information carried by the 2D barcode includes the second character string; and an access controller coupled with the sub station; a master station wirelessly coupled with the sub stations in the plurality of sub control devices; and a master control device coupled with the master station and configured to communicate with the 2D barcode scanning devices and the access controllers in the plurality of sub control devices via the sub stations in the plurality of sub control devices and the master station.

Optionally, the information carried by the 2D barcode further includes a preset random character following the second character string.

Optionally, the master control device is configured to: receive, via the master station, the information carried by the 2D barcode transmitted by the sub station; and compare the preset random character with a random character issued by the server, to determine whether the information carried by the 2D barcode is correct.

Optionally, the 2D barcode scanning device is configured to generate a first Cyclic Redundancy Check (CRC) code using the second character string, and the information carried by the 2D barcode further includes the first CRC code.

Optionally, the master control device is configured to: receive, via the master station, the information carried by the 2D barcode transmitted by the sub station; calculate a second CRC code based on the received second character string; and compare the first CRC code with the second CRC code, to determine whether the second character string is correct.

Optionally, the second character string includes a timestamp; the master control device is configured to: receive, via the master station, the information carried by the 2D barcode; and feed back an instruction for the second character string; and the master station is configured to: record an anomaly, if receiving the second character string including the timestamp again after an acknowledgement to the instruction is received from the access controller.

In an embodiment of the present disclosure, a storage medium having computer instructions stored therein is provided, wherein once the computer instructions are executed, the above 2D barcode encryption method is performed.

Embodiments of the present disclosure may provide following advantages. In embodiments of the present disclosure, a first character string of a first numeral system is generated based on information of a user. The first character string is converted into a second character string of a second numeral system using a preset codebook, wherein the preset codebook is updated according to a first preset period, and a base number of the second numeral system is greater than that of the first numeral system. A 2D barcode is generated using the second character string. By converting the first character string of the first numeral system into the second character string of the second numeral system, a data size of the second character string is smaller than that of the first character string, which may reduce length of the 2D barcode and further improve an identification speed and a transmission speed of the 2D barcode. Besides, the preset codebook is updated according to a first preset period. Therefore, during different time periods, the same first character string may be converted into different second character strings, so that lawless persons cannot pass access control using the same 2D barcode, which may guarantee security of usage of the 2D barcode.

Further, the base number of the first numeral system is 10, and the base number of the second numeral system is 64. As the base number of the second numeral system is greater, the data size of the second character string is smaller. However, a computer language includes special symbols which may instruct a computer to execute a specific operation, and thus the number of characters available in the second numeral system is limited. Therefore, in some embodiments, the base number of the second numeral system is 64, which may also reduce the data size of the second character string, and guarantee the availability of the second character string.

Further, the information of the user includes ID of the user, the first character string includes a character corresponding to the ID of the user, and the character corresponding to the ID of the user is disposed in a preset position of the first character string. The first character string includes a character corresponding to the ID of the user, so as to distinguish different users. Besides, the character corresponding to the ID of the user is disposed in the preset position of the first character string, so that the scanning device can acquire the character, which may facilitate accurate and rapid identification of the user.

### BRIEF DESCRIPTION OF THE DRAWINGS

FIG. 1 is a flow chart of a 2D barcode encryption method according to an embodiment;

FIG. 2 is a structural diagram of a 2D barcode transmission system according to an embodiment;

FIG. 3 is a sequence diagram of interaction among components in a 2D barcode transmission system according to an embodiment;

FIG. 4 is a structural diagram of a sub control device according to an embodiment; and

FIG. 5 is a sequence diagram of interaction among components in a 2D barcode transmission system according to another embodiment.

### DETAILED DESCRIPTION

As described in background, a shared space is a space shared by multiple users. For example, a single office can be shared with people throughout the building or even in the whole society. Because of the large number of users involved in the shared space, existing 2D barcode encryption methods cannot meet security requirements of the shared space for access control.

In embodiments of the present disclosure, by converting a first character string of a first numeral system into a second character string of a second numeral system, a data size of the second character string is smaller than that of the first character string, which may reduce length of a 2D barcode and further improve an identification speed and a transmission speed of the 2D barcode. Besides, a preset codebook is updated according to a first preset period. Therefore, during different time periods, the same first character string may be converted into different second character strings, so that lawless persons cannot pass access control using the same 2D barcode, which may guarantee security of usage of the 2D barcode.

In order to clarify the object, characteristic and advantages of embodiments of the present disclosure, embodiments of present disclosure will be described clearly in detail in conjunction with accompanying drawings.

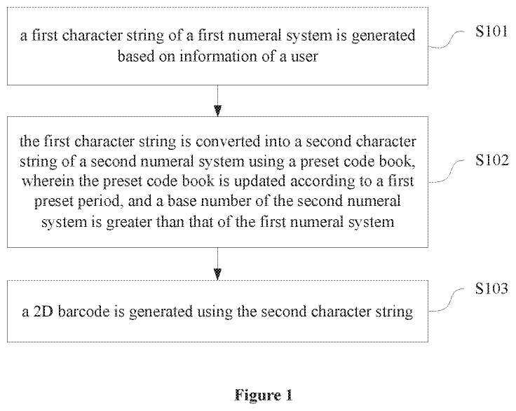

FIG. 1 is a flow chart of a 2D barcode encryption method according to an embodiment. The method includes S101, S102 and S103.

In S101, a first character string of a first numeral system is generated based on information of a user.

In S102, the first character string is converted into a second character string of a second numeral system using a preset codebook, wherein the preset codebook is updated according to a first preset period, and a base number of the second numeral system is greater than that of the first numeral system.

In S103, a 2D barcode is generated using the second character string.

Regarding S101, in some embodiments, the information of the user may be necessary information included in information carried by the generated 2D barcode. Specifically, the information of the user may include a user ID, a timestamp, a latitude and longitude, a Service Set Identifier (SSID), and the like. The latitude and longitude may be obtained by a Global Positioning System (GPS). The SSID may be a WiFi hotspot to which the user is currently connected.

To reduce a data size of the generated 2D barcode, in S102, the first character string is converted into the second character string of the second numeral system, wherein the base number of the second numeral system is greater than that of the first numeral system.

In some embodiments, the base number of the first numeral system is 10, and the base number of the second numeral system is greater than 10.

Regarding S102, in some embodiments, the first character string may be converted as a whole to the second character string of the second numeral system. In some embodiments, if the first character string includes a plurality of sub character strings, the plurality of sub character strings may be converted into second sub character strings of the second numeral system respectively, and then the second sub character strings are spliced into the second character string corresponding to the information of the user. For example, if the information of the user includes the user ID, the timestamp, the latitude and longitude, and the SSID, portions of the first character string corresponding to the user ID, the timestamp, the latitude and longitude, and the SSID may be converted into second sub character strings respectively, and then the second sub character strings corresponding to the user ID, the timestamp, the latitude and longitude, and the SSID are spliced into the second character string corresponding to the information of the user.

In some embodiments, the preset codebook may provide available characters of the second character string. A process of converting the first character string of the first numeral system into the second character string of the second numeral system may be referred to existing numeral system conversion algorithm, and is not described in detail here.

Further, the preset codebook may be updated according to the first preset period. That is, the preset codebook used to convert the first character string into the second character string of the second numeral system may be different in different time periods. Accordingly, the second character string converted from the same first character string in different time periods may be different. Even if the second character string in one time period is intercepted, the second character string cannot be used. For example, in an application scenario where 2D barcodes are used to pass access control, even if a lawless person intercepts a 2D barcode, he/she cannot pass the access control based on the 2D barcode.

In S103, the 2D barcode is generated using the second character string.

The 2D barcode may be generated by any related algorithm in existing techniques, which is not limited here.

In embodiments of the present disclosure, by converting the first character string of the first numeral system into the second character string of the second numeral system, the data size of the second character string is smaller than that of the first character string, which may reduce the length of the 2D barcode and further improve the identification speed and the transmission speed of the 2D barcode. Besides, the preset codebook is updated according to the first preset period. Therefore, during different time periods, the same first character string may be converted into different second character strings, so that lawless persons cannot pass access control using the same 2D barcode, which may guarantee security of usage of the 2D barcode.

In some application scenarios, the 2D barcode needs to be verified to trigger a specific operation, such as passing access control. In this case, the 2D barcode is recognized by a scanning device as the second character string, the second character string is directly verified, and if the verification is passed, the specific operation can be triggered.

In some embodiments, after the 2D barcode is recognized by the scanning device as the second character string, the second character string is converted into the first character string by using the preset codebook to acquire information of each field carried by the first character string, such as a user ID, or a latitude and longitude of the user. Afterward, the information is verified, and if the verification is passed, the specific operation can be triggered.

In some embodiments, the base number of the first numeral system is 10, and the base number of the second numeral system is 64.

In some embodiments, the first character string may be expressed in decimalism, and may include numbers and ASCII codes. As the base number of the second numeral system is relatively large, the data size of the second character string is smaller. However, a computer language includes special symbols which may instruct a computer to execute a specific operation, and thus the number of characters available in the second numeral system is limited. Therefore, in some embodiments, the base number of the second numeral system is 64, which may also reduce the data size of the second character string, and guarantee the availability of the second character string.

In some embodiments, the preset codebook includes a plurality of characters arranged in order, and the order is updated according to a second preset period.

In some embodiments, the preset codebook may include a plurality of characters, and the number of the plurality of characters is the base number of the second numeral system. The order of the plurality of characters in the preset codebook affects conversion correspondence between the first character string and the second character string. In other words, the same first character string may be converted into different second character strings based on characters in different orders. Therefore, by updating the order of the plurality of characters in accordance with the second preset period, security of conversion from the first character string to the second character string may be guaranteed.

In some embodiments, the plurality of characters are selected from a group consisting of numbers 0 to 9, capital letters from A to Z, lowercase letters from a to z, and punctuation.

In some embodiments, the plurality of characters do not include special characters instructing the computer to perform a specific operation, such as a slash ‘/’, an and operator ‘&’ or an asterisk ‘*’. For example, the plurality of characters in the preset codebook may include: 0 to 9 (10 digits), A to Z (26 digits), a to z (26 digits), exclamation mark ‘!’ (1 digit), underscore ‘_’ (1 digit). The characters may be arranged in order to form the preset codebook, for example, “tB_uTaJGzwkUS3xcpX7ns9OAgLq62WCoNEhdj5rf8ePylZi4DMQKVIHmYb01vF!R”.

In some embodiments, the information of the user includes a user ID, and the first character string includes a character corresponding to the user ID.

In some embodiments, users with different IDs may have different rights, and thus the user IDs may be embodied in the 2D barcode. That is, the first character string may include a character corresponding to the user ID, and accordingly the second character string also includes a character corresponding to the user ID, which enables the 2D barcode to carry information of the user ID. For example, the character A represents a normal user, the character B represents a visitor, and the character S represents an administrator or the like.

In some application scenarios, if a user has the right to pass access control of a gym, a conference room and an elevator, a character corresponding to the user ID may be set, so that the user doesn't need to present different 2D barcodes. The user can use the same 2D barcode to open the above access control, which improves convenience of the user to use the 2D barcode.

In some embodiments, to distinguish different users, the first character string includes a character corresponding to ID of the user.

In some embodiments, the character corresponding to the ID of the user is disposed in a preset position of the first character string.

In some embodiments, to enable a scanning device to acquire the character corresponding to the ID of the user, the character may be disposed in the preset position of the first character string, which may facilitate accurate and rapid identification of the user.

For example, the character A represents a normal user, the character B represents a visitor. If the user is a member in a platform, when the 2D barcode is displayed on a terminal of the user, a starting character of information carried by the 2D barcode is ‘A’. If the user is a visitor, when the 2D barcode is displayed on a terminal of the user, a starting character of information carried by the 2D barcode is ‘B’.

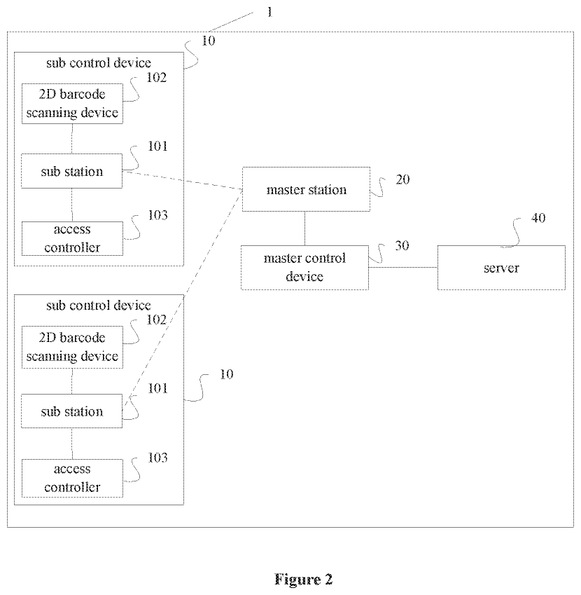

Referring to FIG. 2, FIG. 2 is a structural diagram of a 2D barcode transmission system according to an embodiment.

The 2D barcode transmission system 1 includes a server 40, a plurality of sub control devices 10 disposed in a plurality of shared spaces, a master station 20 and a master control device 30.

Each of the plurality of sub control devices 10 includes: a sub station 101; a 2D barcode scanning device 102, configured to scan a 2D barcode on a UE to acquire information carried by the 2D barcode, wherein the information carried by the 2D barcode is transmitted by the sub station 101, the 2D barcode is generated by the UE or a server 40, and the information carried by the 2D barcode includes the second character string; and an access controller 103 coupled with the sub station 101.

In some embodiments, the UE or the server 40 may generate the 2D barcode using the method as shown in FIG. 1. The periodic update of the preset codebook may be performed by the server 40. After the update, the server 40 may synchronously transmit the updated codebook to the 2D barcode scanning device 102 and the master control device 30, so that the 2D barcode scanning device 102 and the master control device 30 are capable of analyzing received information. In addition, if the 2D barcode is generated by the UE, the server 40 further needs to transmit the codebook to the UE for use.

In some embodiments, the 2D barcode scanning device 102 may transmit information carried by the scanned 2D barcode to a controller (not shown in figures, such as a single-chip microcomputer or other various general-purpose or dedicated control circuits), and the controller transmits the information to the sub station 101.

The 2D barcode scanning device 102 may be installed outside the shared space (for example, at a door outside of a shared conference room) to facilitate scanning by the UE. The sub station 101 and the access controller 103 may be installed outside or inside the shared space, preferably inside the shared space (for example, inside the shared conference room) to improve security.

The access controller 103 may control the opening or closing of the access control of the shared space.

The master station 20 is wirelessly coupled with the sub stations 101 in the plurality of sub control devices.

The master control device 30 is coupled with the master station 20 and configured to communicate with the 2D barcode scanning devices 102 and the access controllers 103 in the plurality of sub control devices via the sub stations 101 in the plurality of sub control devices and the master station 20.

The server 40 may be a remote server with respect to the shared space. For example, the master control device 30 in a plurality of buildings or in a campus may be connected to the same server 40 through a wired network, a wireless network, or the like.

In some embodiments, the UE may be a mobile phone, a wearable device, or the like.

In some embodiments, the master control device 30 may receive the information carried by the scanned 2D barcode which is acquired by the 2D barcode scanning device 102 via the master station 20 and the sub stations 101. The master control device 30 may transmit a message, such as a control instruction, to the access controller 103 via the master station 20 and the sub stations 101.

In some embodiments, the information carried by the scanned 2D barcode which is acquired by the 2D barcode scanning device 102 may be transmitted through the sub station 101, and the master station 20 may receive the information. The master station 20 may forward the information carried by the scanned 2D barcode to the master control device 30.

It should be noted that the master control device 30 may be any computer device with information processing capability, for example, a micro host with an Android operating system installed.

In some embodiments, communication between the sub station 101 and the master station 20 may be point-to-point communication. The master station 20 can also acquire ID of the sub station 101 while receiving the information carried by the 2D barcode, and further acquire ID of the shared space where the sub station 101 is located.

In some embodiments, one sub control device 10 may be disposed in each shared space. The master station 20 may be wirelessly coupled with the plurality of sub stations 101, and the master control device 30 may communicate with the plurality of 2D barcode scanning devices 102 and the plurality of access controllers 103. For example, there may be a plurality of shared conference rooms in a same building or campus, each conference room is configured with a sub control device 10, and only one master station 20 and one master control device 30 may be set in the building or campus to communicate with the sub control devices 10. Alternatively, it is also possible to set a plurality of master stations 20 and a plurality of master control devices 30 in a building or campus, especially in the case of a large building or campus.

It should be noted that the number of the sub stations 101 wirelessly coupled with each master station 20 may be determined according to actual application requirements and communication distance, which is not limited here.

In some embodiments, the sub station 101 and the master station 20 may communicate using an open radio frequency band or using radio communication technologies such as Global System for Mobile Communication (GSM) or LoRa radio communication.

In some embodiments, the master control device 30 receives the information carried by the 2D barcode which is transmitted by the sub station 101 via the master station 20 and the sub station 101.

In some embodiments, the information carried by the 2D barcode further includes a preset random character following the second character string. In some embodiments, the preset random character may be spliced following the second character string when the server 40 or the UE generates the 2D barcode or after the 2D barcode scanning device 102 identifies the 2D barcode.

In some embodiments, when the UE generates the 2D barcode, the preset random character may be sent to the UE in advance by the server 40. If the preset random character is spliced by the 2D barcode scanning device 102, the preset random character may be transmitted to the 2D barcode scanning device 102 by the server 40 in advance.

In some embodiments, the master control device 30 is configured to: receive, via the master station 20, the information carried by the 2D barcode transmitted by the sub station 101; and compare the preset random character with a random character issued by the server 40, to determine whether the information carried by the 2D barcode is correct.

In the above embodiments, the information carried by the 2D barcode is verified based on the preset random character contained in the information carried by the 2D barcode, which prevents the information carried by the 2D barcode from being embezzled and further guarantees security of the information carried by the 2D barcode during transmission.

In some embodiments, the 2D barcode scanning device 102 may be configured to generate a first CRC code using the second character string, and the information carried by the 2D barcode further includes the first CRC code.

In some embodiments, the master control device 30 is configured to: receive, via the master station 20, the information carried by the 2D barcode transmitted by the sub station 101; generate a second CRC code based on the received second character string; and compare the first CRC code with the second CRC code, to determine whether the second character string is correct.

In some embodiments, the first CRC code calculated by the 2D barcode scanning device 102 is compared with the second CRC code calculated by the master control device 30, and if the second CRC code is consistent with the first CRC code, it is indicated that the second character string is correctly transmitted and may be used to generate an instruction to instruct the access controller 103 to open the access control. If the second CRC code is inconsistent with the first CRC code, it is indicated that the second character string is incorrectly transmitted and may be used to generate an instruction to instruct the access controller 103 to close the access control.

In some embodiments, the second character string includes a timestamp. The master control device 30 is configured to: receive, via the master station 20, the information carried by the 2D barcode; and feed back an instruction for the second character string. The master station 20 is configured to: record an anomaly, if receiving the second character string including the timestamp again after an acknowledgement to the instruction is received from the access controller 103.

In this embodiment, as the second character string includes a timestamp, second character strings at different time points are not the same.

After receiving the information carried by the 2D barcode, the master station 20 may record the second character string therein. In addition, the master station 20 may further record feedback from the access controller 103 for each control instruction. If the master station receives the second character string after receiving the feedback for the same second character string (that is, content of the second character strings is the same), it is indicated that the second character string is illegally used, and an anomaly is recorded. Further, the master station 20 will not transmit the same second character string received to the master control device 30. In this way, an abnormal second character string can be prevented from being used for controlling the access controller 103, which may guarantee security of usage of the 2D barcode.

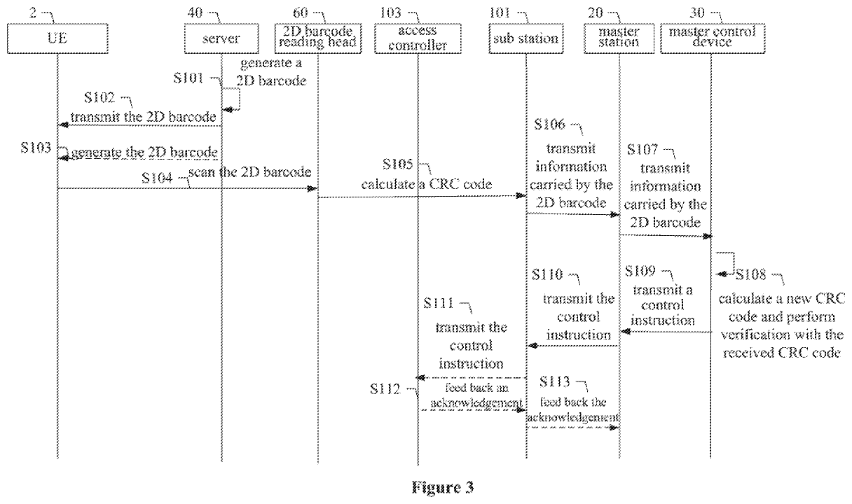

In an application scenario, referring to FIG. 3, the server 40 may perform S101 and S102 to generate a 2D barcode and transmit it to a UE 2. Alternatively, the UE 2 may perform S103 to generate the 2D barcode.

A process of generating the 2D barcode by the server 40 or the UE 2 may be referred to the embodiments as shown in FIG. 1, and is not described in detail here.

In S104, a 2D barcode reading head 60 scans the 2D barcode provided by the UE 2 to acquire information carried by the 2D barcode. In S105, the 2D barcode reading head 60 calculates a CRC code to be spliced following a second character string. In S106 and S107, the information carried by the 2D barcode is transmitted to the master control device 30 via the sub station 101 and the master station 20. In S108, the master control device 30 may calculate a new CRC code and perform verification with the received CRC code. If the new CRC code is consistent with the received CRC code, in S109 to S111, a control instruction is transmitted to the access controller 103 via the master station 20 and the sub station 101. In S112 and S113, after the access controller 103 executes the control instruction, an acknowledgement may be fed back to the master station 20. In this way, a complete process of reading information carried by the 2D barcode, issuing an instruction and receiving an instruction execution result is completed.

In some embodiments, the information carried by the 2D barcode may be illegally intercepted during its transmission from the sub station 101 to the main station 20, and the signal may be replayed. When the master station 20 receives the information for the first time, it will execute normally. When the same information is received for the second time, it will be discarded without being processed, and the master station 20 may record a log message to record the abnormal behavior (for example, subjected to being replayed).

In some embodiments, the master control device 30 may also perform verification on the information carried by the 2D barcode, generate a control instruction based on a verification result, and transmit the control instruction to the sub control device 10 via the master station 20. The control instruction is at least used to control the access controller 103 to open or close the access control of the shared space.

In some embodiments, the master control device 30 may generate the control instruction based on the verification result. Specifically, when the verification result indicates that the information carried by the 2D barcode pass the verification, a first control instruction (i.e., a door opening instruction) that controls opening of the access control of the shared space is generated. When the verification result indicates that the information carried by the 2D barcode fails to pass the verification, a second control instruction (i.e., an instruction for keeping the door closed) that prohibits opening of the access control of the shared space is generated.

The control instruction generated by the master control device 30 is transmitted via the master station 20. The sub station 101 may receive the control instruction transmitted by the master station 20, and forward the received control instruction to the access controller 103 which can execute the control instruction. More specifically, the sub station 101 may transmit the received control instruction to the controller which then forwards the control instruction to the access controller 103.

In embodiments of the present disclosure, the master control device 30 synchronizes authentication data from the server 40 to local, and performs verification on the information of the user locally, which may improve a speed of verification and improve access control efficiency of the shared space. Further, by performing verification in a local area network (the master control device 30 and the sub control devices 10 may be in the same local area network), it is possible to avoid an excessive load caused by frequent access to the server 40.

In some embodiments, when the master control device 30 performs verification on the information of the user based on the authentication data, the information of the user may be compared with authorized user information in the authentication data. If the information of the user is consistent with the authorized user information, it is indicated that the verification is passed; otherwise, the information of the user fails to pass the verification.

In the above embodiments, the master control device 30 synchronizes authentication data from the server 40 to local, and performs verification on the information of the user locally, which may improve a speed of verification and improve access control efficiency of the shared space. Besides, when network environment is unstable and the network is blocked, by performing verification in the local area network, communication with the sub control device 10 in the shared space can be conducted normally to further improve user experience.

Still referring to FIG. 2, in some embodiments, the master control device 30 may transmit the information of the user to the server 40 for verification, and receive a verification result from the server 40.

In some embodiments, the server 40 may generate authentication data, receive the information carried by the 2D barcode from the master control device 30, and perform verification on the information carried by the 2D barcode by using the generated authentication data. After the verification, the server 40 transmits the verification result to the master control device 30. Further, the server 40 may also generate a control instruction and transmit the control instruction to the master control device 30.

It could be understood that the process of the server 40 performing verification on the information carried by the 2D barcode using the generated authentication data is similar with the process of the master control device 30 performing verification on the information of the user using the authentication data, which is not described in detail here.

In some embodiments, the master control device 30 receives the verification result from the server 40 and generates a control instruction based on the verification result.

In some embodiments, the master control device 30 is further configured to encrypt the control instruction, and transmit the encrypted control instruction to the sub control device 10.

In the above embodiments, to ensure security of transmission of the control instruction, the master control device 30 encrypts the control instruction. A static or dynamic encryption method may be employed to encrypt the control instruction.

In some embodiments, the master control device 30 may encrypt the control instruction using a dynamic encryption method, and thus the encrypted control instruction may be different at different times. Specifically, the master control device 30 may calculate a key based on the received information of the user and encrypt the control instruction with the key.

Still referring to FIG. 2, the server 40 may generate a 2D barcode and transmit it to the UE. For example, the user logs in to the server 40 through the UE, makes a reservation for a specific shared space, and inputs a user ID, and the server 40 generates the 2D barcode based on the information input by the user.

In some embodiments, the 2D barcode generated by the server 40 may be scanned and read by the 2D barcode scanning device 102. For example, the server 40 may generate the 2D barcode that carries ID information.

The server 40 generates the 2D barcode by the method as shown in FIG. 1, which may reduce a data size of the 2D barcode. As the master control device 30 is wirelessly communicated with the 2D barcode scanning device 102 and the access controller 103, open available radio frequency is relatively low, and is prone to be attenuated and interfered. Therefore, to guarantee a data transmission speed and transmission quality, the sub station 101 and the master station 20 are used to transmit the above-mentioned 2D barcode, which ensures normal communication between the master control device 30 and the sub control devices 10 in the shared space.

Further, the server 40 receives heartbeat information of each sub station 101 and the master control device 30 from the master control device 30, and monitors the sub control devices 10 and the master control device 30 based on the received heartbeat information.

In some embodiments, the sub station 101 may transmit the heartbeat information of the sub station 101 to the master control device 30 via the master station 20. The master control device 30 reports its own heartbeat information and the heartbeat information of the sub station 101 to the server 40. The server 40 may monitor whether the sub station 101 and the master control device 30 operate abnormally based on the heartbeat information reported by the master control device 30.

In some embodiments, the master control device 30 may report its own heartbeat information and the heartbeat information of the sub station 101 to the server 40 according to a preset period. If the server 40 does not receive the heartbeat information of the sub-station 101 or the heartbeat information of the master control device 30 within the preset period, it is indicated that the sub station 101 or the master control device 30 is abnormal, and the server 40 may generate an alarm to prompt relevant personnel to troubleshoot the sub station 101 or the master control device 30 in time.

In some embodiments, the server 40 may be provided with a shared space registration module (not shown in figures), a user registration module (not shown in figures) and a search module (not shown in figures).

In some embodiments, the shared space registration module is configured to record spatial information of each shared space, wherein the spatial information includes location, area, rent and internal facilities. The user registration module is configured to record user information which includes ID of a user. The search module is configured to search for a shared space that matches a search condition of the user.

In some embodiments, the user may access the server 40 using the UE. The user inputs the ID of the user, and the user registration module records the ID to complete the user registration. The user may further input the search condition for a shared space, and the search module compares the search condition with spatial information of shared spaces recorded in the shared space registration module to determine the shared space that matches the search condition input by the user. In this way, the user completes reservation for the shared space.

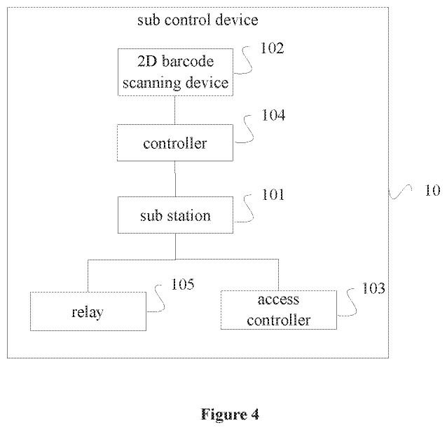

Referring to FIGS. 2 and 4, in some embodiments, the sub control device 10 further includes a controller 104 coupled with the 2D barcode scanning device 102 and the sub station 101, and configured to receive the information carried by the 2D barcode and calculate a key based on the information of the user, wherein the key is used to decrypt the encrypted control instruction. In some embodiments, the controller 104 and the master control device 30 may calculate the key using the same algorithm, and the key calculated by the controller 104 is consistent with the key calculated by the master control device 30. Therefore, the key calculated by the controller 104 can be used to decrypt the encrypted control instruction.

Still referring to FIGS. 2 and 4, in some embodiments, the sub control device 10 further includes a relay 105 connected with a heavy-current circuit of the shared space. The relay 105 is configured to communicate with the master control device 30 via the sub station 101 and the master station 20.

In some embodiments, the relay 105 is connected with the heavy-current circuit of the shared space to control the connection or disconnection of the heavy-current circuit. For example, when the relay 105 is turned on, the heavy-current circuit is connected with a power supply, so that equipment such as sockets or lighting can operate normally. When the relay 105 is disconnected, the heavy-current circuit is disconnected from the power supply, so that equipment such as sockets or lighting cannot operate normally.

In some embodiments, the master control device 30 transmits a control instruction to the relay 105 via the master station 20 and the sub station 101, and the relay 105 may control opening or closing of the heavy-current circuit in response to the control instruction.

In some embodiments, the access controller 103 may be implemented using a weak-current circuit. Therefore, the combination of the access controller 103 and the relay 105 realizes linkage control of the heavy-current and weak-current circuits of the shared space, so as to save labor and operation costs, and achieve energy conservation and environmental protection.

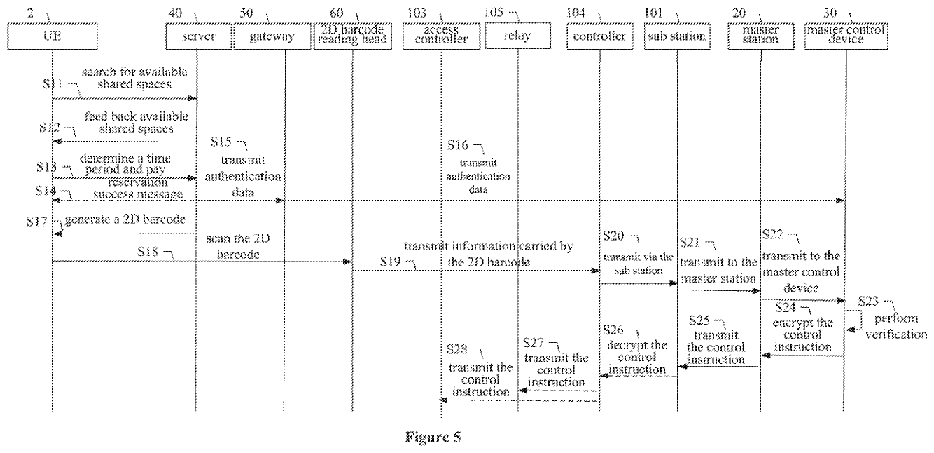

FIG. 5 is a sequence diagram of interaction among components in a 2D barcode transmission system and a UE 2 according to another embodiment.

In some embodiments, the UE 2 may perform S11 using a webpage, a public account, an application or the like, and search for available shared spaces from the server 40, for example, searching for the available shared spaces using various conditions such as price, distance, area or internal facilities.

In S12, the server 40 feeds back the available shared spaces to the UE 2 for presentation to the user. In S13, the UE 2 selects a shared space, determines a time period for using the shared space, and performs payment. In S14, the server 40 may transmit a reservation success message to the UE 2, and performs S15 and S16 to transmit authentication data to the master control device 30 via a gateway 50 of the Internet of Things. The authentication data includes ID of the UE 2 and ID of the selected shared space.

Afterward, the server 40 performs S17 to generate a 2D barcode and deliver it to UE 2. The 2D barcode can be sent to other terminals by screenshot or WeChat. Specifically, the server 40 may perform compression and encryption on the 2D barcode and then deliver the compressed and encrypted 2D barcode to the UE 2. In S18, the UE 2 provides the 2D barcode for scanning before predetermined minutes (for example, 10 minutes) ahead of the determined time period. The 2D barcode reading head 60 may scan the 2D barcode provided by the UE 2.

In S19, the 2D barcode reading head 60 transmits information carried by the scanned 2D barcode to the controller 104. Specifically, the information carried by the scanned 2D barcode includes information of the user. The controller 104 may dynamically generate a key based on the information carried by the scanned 2D barcode, wherein the key may be stored in the controller 104 and used to decrypt a control instruction in subsequent steps.

In S20, S21 and S22, the information carried by the 2D barcode is transmitted to the master control device 30 via the sub station 101 and the master station 20. The master control device 30 performs S23 to perform verification on the information of the user in the information carried by the 2D barcode, and determines a control instruction, such as whether to open access control or whether to open a heavy-current circuit. In some embodiments, after receiving the encrypted information carried by the 2D barcode, the master control device 30 may first decrypt the encrypted information carried by the 2D barcode, and then perform verification on the decrypted information carried by the 2D barcode.

In S24, the master control device 30 may generate and use a key to encrypt the control instruction based on the information carried by the 2D barcode. In S25 and S26, the control instruction is transmitted to the controller 104 via the master station 20 and the sub station 101, and the controller 104 decrypts the control instruction based on the key calculated in S19.

In S27 and S28, the controller 104 transmits the decrypted control instruction to the relay 105 and/or the access controller 103. For example, the access controller 103 executes the instruction to open the access control, or the relay 105 executes the instruction to power the heavy-current circuit. In this way, the user enters and uses the selected shared space.

More details about the interaction process among components in the 2D barcode transmission system and the UE 2 can be found in the above descriptions of FIGS. 1 to 4, and are not described here.

In an embodiment of the present disclosure, a storage medium having computer instructions stored therein is provided, wherein once the computer instructions are executed, the 2D barcode encryption method as shown in FIG. 1 is performed. The storage medium may include a Read Only Memory (ROM), a Random Access Memory (RAM), a magnetic disk, an optical disk or the like. Alternatively, the storage medium may include a non-volatile or non-transitory memory or the like.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A two-dimensional (2D) barcode encryption method, comprising:
generating a first character string of a first numeral system based on information of a user;
converting the first character string into a second character string of a second numeral system using a preset codebook, wherein the preset codebook is updated according to a first preset period, and a base number of the second numeral system is greater than that of the first numeral system; and
generating a 2D barcode using the second character string.

2. The method according to claim 1, wherein the base number of the first numeral system is 10, and the base number of the second numeral system is 64.

3. The method according to claim 1, wherein the preset codebook comprises a plurality of characters arranged in order, wherein the order is updated according to a second preset period.

4. The method according to claim 3, wherein the plurality of characters are selected from a group consisting of numbers from 0 to 9, capital letters from A to Z, lowercase letters from a to z, and punctuation.

5. The method according to claim 1, wherein the information of the user comprises Identification (ID) of the user, and the first character string comprises a character corresponding to the ID of the user.

6. The method according to claim 5, wherein the character corresponding to the ID of the user is disposed in a preset position of the first character string.

7. A two-dimensional (2D) barcode transmission system, comprises:
a server;
a plurality of sub control devices disposed in a plurality of shared spaces, wherein each of the plurality of sub control devices comprises:
a sub station;
a 2D barcode scanning device, configured to scan a 2D barcode on a User Equipment (UE) to acquire information carried by the 2D barcode, wherein the information carried by the 2D barcode is transmitted by the sub station, the 2D barcode is generated by the UE or a server according to the method of claim 1, and the information carried by the 2D barcode comprises the second character string; and
an access controller coupled with the sub station;
a master station wirelessly coupled with the sub stations in the plurality of sub control devices; and
a master control device coupled with the master station and configured to communicate with the 2D barcode scanning devices and the access controllers in the plurality of sub control devices via the sub stations in the plurality of sub control devices and the master station.

8. The system according to claim 7, wherein the information carried by the 2D barcode further comprises a preset random character following the second character string.

9. The system according to claim 8, wherein the master control device is configured to: receive, via the master station, the information carried by the 2D barcode transmitted by the sub station; and compare the preset random character with a random character issued by the server, to determine whether the information carried by the 2D barcode is correct.

10. The system according to claim 7, wherein the 2D barcode scanning device is configured to generate a first Cyclic Redundancy Check (CRC) code using the second character string, and the information carried by the 2D barcode further comprises the first CRC code.

11. The system according to claim 10, wherein the master control device is configured to: receive, via the master station, the information carried by the 2D barcode transmitted by the sub station; calculate a second CRC code based on the received second character string; and compare the first CRC code with the second CRC code, to determine whether the second character string is correct.

12. The system according to claim 7, wherein the second character string comprises a timestamp;
the master control device is configured to: receive, via the master station, the information carried by the 2D barcode; and feed back an instruction for the second character string; and
the master station is configured to: record an anomaly, if receiving the second character string comprising the timestamp again after an acknowledgement to the instruction is received from the access controller.

13. A storage medium having computer instructions stored therein, wherein once the computer instructions are executed, the method according to claim 1 is performed.
